(19) United States
(12) Patent Application Publication
(10) Pub. No.: US 2015/0108969 A1
(43) Pub. Date: Apr. 23, 2015

(54) On-Chip Linear Variable Differential Transformer

(71) Applicant: Texas Instruments Incorporated, Dallas, TX (US)

(72) Inventor: William Robert Krenik, Garland, TX (US)

(21) Appl. No.: 14/508,079

(22) Filed: Oct. 7, 2014

Related U.S. Application Data
(60) Provisional application No. 61/894,219, filed on Oct. 22, 2013.

(51) Int. Cl. G01D 5/20

(52) U.S. Cl. CPC G01D 5/204
USPC 324/207.18

(57) ABSTRACT

A linear variable differential transformer (“LVDT”) including a semiconductor substrate and a plurality of coils formed at least partially on the substrate.

This application claims the benefit of U.S. Provisional Patent Application Ser. No. 61/894,219, filed Oct. 22, 2013, which is hereby incorporated by reference for all that it contains.

### BACKGROUND

A linear variable displacement transformer (“LVDT”) is a type of electrical transformer used for measuring linear displacement of an object. The LVDT's relatively simple construction and robust operation make it ideal for measurement of linear displacements of objects in harsh environments such as aviation, naval, medical and nuclear environments. Although reliable, LVDT's are relatively expensive to produce.

### BRIEF DESCRIPTION OF THE DRAWINGS

FIG. 1 is a schematic drawing of a prior art linear variable displacement transducer.

FIG. 2 is a schematic side elevation view of an on-chip LVDT.

FIG. 3 is a schematic illustration of certain electromagnetic components provided within a silicon substrate.

FIG. 4 is a schematic, broken away, isometric view of an example embodiment of an on-chip LVDT having coils provided by connected conductor strips in different layers of a semiconductor substrate.

FIG. 5 is an isometric view of an assembly including a semiconductor substrate with a coil formed thereon, a tubular member and a displaceable member positioned within the tubular member.

FIG. 6 is an end view of the assembly of FIG. 5 and further including a mold layer.

FIG. 7 is a flowchart of a method of measuring displacement of an object.

### DETAILED DESCRIPTION

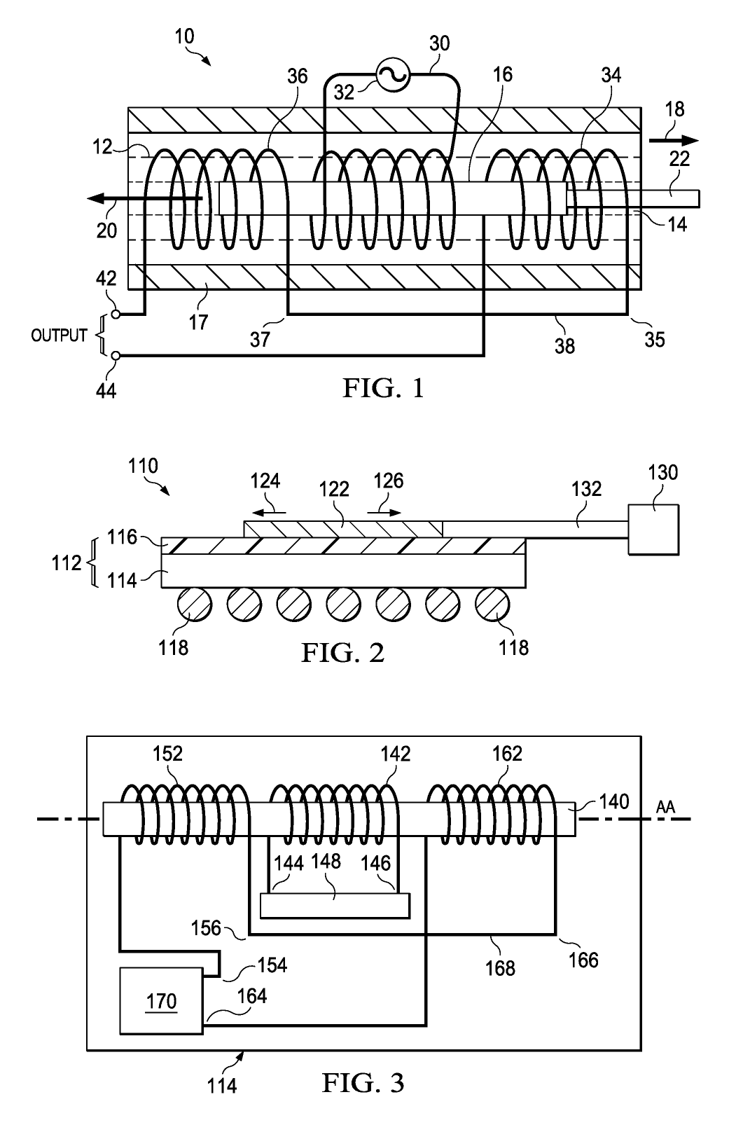

FIG. 1 is a schematic drawing of a linear variable displacement transformer 10. The LVDT includes an elongated tubular member 12 made from insulating material, e.g. nylon. The tubular member 12, for illustrative purposes, is shown as transparent and indicated by two dashed lines. The tubular member 12 has a central cylindrical hole 14 therein, which is shown in dotted lines, A cylindrical core assembly 16 sometimes referred to as a core member 16, is slidably received within the hole 14. The core member 16 is displaceable in a first linear movement direction 18 and an opposite second linear movement direction 20. A coupling shaft 22 is connected to one end of the core member 16 and used to attach the core member 16 to an object (not shown), the displacement of which is to be measured.

As further shown in FIG. 1 a primary coil 30, which receives an alternating current (“AC”) excitation voltage from a voltage source 32, is wound around the tubular member 12 and is electrically insulated with respect to the core member 16, by the tubular member 12. The central longitudinal axis of the core member 16 is coaxial with the central longitudinal axis of the primary coil 30.

A first secondary coil 34 is positioned adjacent to one end of the primary coil and has a central longitudinal axis coaxial with that of the primary coil. A second secondary coil 36 is located on a second side of the primary coil 30 and also has a central longitudinal axis coaxial with the central longitudinal axis of the primary coil 30. Both the first secondary coil 34 and the second secondary coil 36 are wound about the tube 12 of insulating material. A magnetic cylinder made from, for example, soft iron, has a central cylindrical hole 19 therein. The coifs 32, 34 and 36, the insulating tubular member 12 and the core member 16 are all positioned inside cylindrical hole 19.

The secondary coils 34, 36 are typically connected in series and in inverse phase, as by connecting wire 38 that connects first terminal ends 35, 37 thereof. Like the primary coil, the secondary coils are electrically insulated with respect to the core member 16 by insulating tubular member 12. Second terminal ends 42, 44 of the first and second secondary coils 34, 36, provide a differential signal output, which is monitored, The amplitude and phase of the output provide a position measurement of the distance of the longitudinal center point of the core member 16 relative to a centered or null position thereof. In this center position the longitudinal center of the core member is located at the longitudinal center of the primary coil 30. The maximum signal amplitude occurs at an extreme left and extreme right positions of the core member 16.

FIG. 2 is a schematic side elevation view of an on-chip LVDT 10. The on-chip LVDT includes an integrated circuit (“IC”) package 112 that includes a silicon substrate 114 covered by a layer of mold compound 116, which in one embodiment is a layer of epoxy plastic. The IC package 112 has a plurality of electrical contacts 118, which in the illustrated embodiment of FIG. 12 comprise solder balls of a ball grid array. A member 122 made of magnetic material, such as iron, is displaceable relative to the IC package 112 in a first linear direction 124 and an opposite second linear direction 126. An object 130 that is displaceable is attached to the member 122 by a link 132.

FIG. 3 is a schematic view of certain electromagnetic components provided within the silicon substrate 114. A central core member 140 made from magnetic material has a central longitudinal axis AA. A drive circuit inductor coil 142 is wrapped about a central portion of the central core 140. The drive circuit has a first end contact 144 and a second end contact 146 that are attached to a drive circuit 148, which is typically located outside of the substrate 114. A first secondary inductor coil 152 with a first end 154 and a second end 156 is wound about one lateral end portion of the central core member 140. A second secondary inductor coil 162 having a first end 164 and a second and 166 is wound about the other lateral end portion of the central core member 140. The two first ends 154 and 164 are connected to a sensing circuit 170 that that senses the relative position of the core member 140 based upon the difference in the signals between the two secondary coils 152, 162 when the two are connected in series. The second ends 156 166 of the secondary inductor coils are connected together as by a wire 168.

A linking member 132 has one end attached to an end of the displaceable magnetic member 122. The second end of the linking member 132 is attached to an object 130, the displacement of which is to be measured. in another embodiment the second end of the linking member 132 is attached to a displacement transmission assembly, which may include interconnected gears, levers or other mechanical linkage that is also connected to the object 130. This displacement transmission assembly moves the linking member 132 a distance that is proportional to the distance moved by the object.

In operation, when the object 130 moves the movement displaces the linking member 132 a distance that is either the same as or proportional to the distance moved by the object 130. This displacement of linking member 132 is transmitted to displaceable magnetic member 122. The displacement of member 122 causes a change in the magnetic field generated by the drive circuit inductor coil 142 and sensed by the secondary coils 152 and 162. The differential signal produced by secondary coils 152 and 162 and the phase thereof may then be used by appropriate circuitry to determine the distance and direction of displacement of the displaceable magnetic member 122. This distance moved by the displacement of member 122 is the same as or proportional to the displacement of object 130, depending upon the linkage assembly. Thus, the displacement of object 130 is readily determined. The various calculations performed, based upon the differential signal provided by the two secondary coils, may be performed by circuitry within the substrate 114 or circuitry outside the substrate 114, which is connected to the output of the secondary coils 152, 162 through electrical contacts 118.

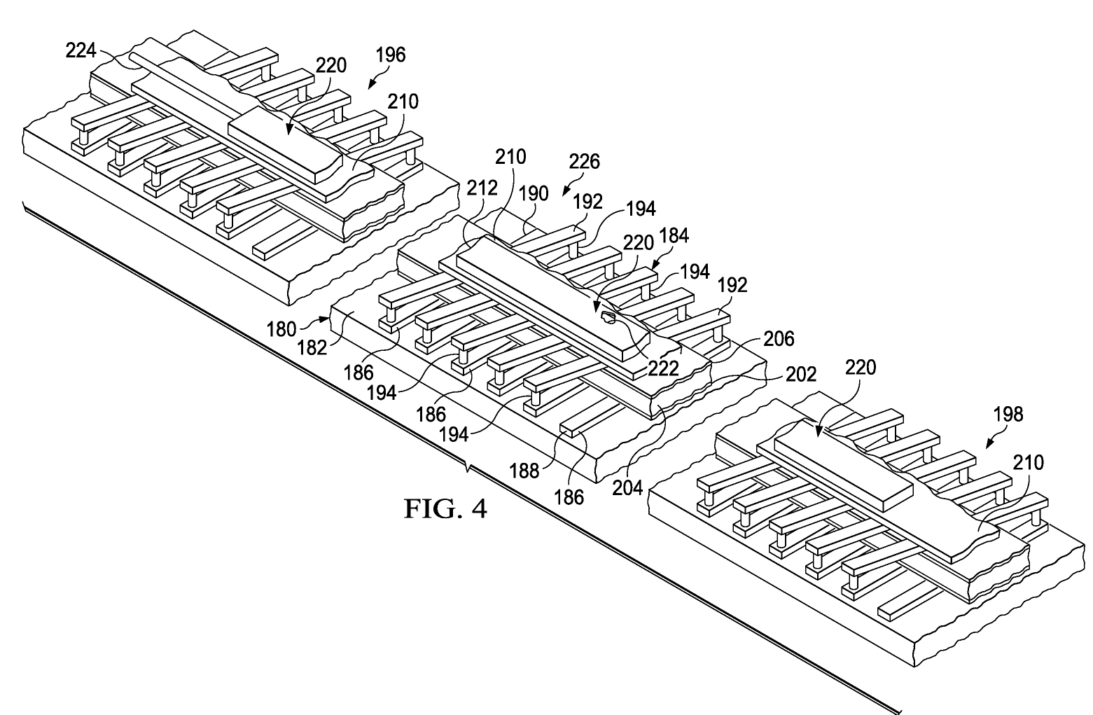

One embodiment of the on-chip LVDT 110 described generally above with reference to FIGS. 2 and 3 is illustrated in FIG. 4. A semiconductor substrate 180 has a lower layer with a top surface 182 formed thereon by conventional means. A primary coil 184 includes a plurality of parallel lower conductor strips 186 that define first and second ends 188, 190 of the primary coil. The lower strips 186 may be conventionally formed on the substrate surface 182. The primary coil 184 also includes a plurality of parallel upper conductor strips 192 that are positioned on a substrate layer formed above that of the lower conductor strips 186. The upper strips 192 are positioned in angled relationship with respect to the lower strips 186, and the end portions of the upper strips overlie the end portions of the lower strips. The two sets of conductor strips 186, 192 are connected at the end portions thereof by vias 194.

Between the time the lower conductor strips 186 are formed on lower layer 182 and the formation of the upper strips 192 other layers of substrate material are formed. A first dielectric layer 202 is formed over the lower conductor strips 186. A narrow width layer 204 of magnetic core material is formed on top of the first dielectric layer 202. A second dielectric layer 206 is formed above the magnetic core layer 204. The primary coil 184 is “wound” around the magnetic core material layer 204 and the dielectric layers 202, 206 by formation and connection of the lower and upper conductor strips 186, 192 and vias 194. The first secondary coil 196 and a second secondary coil 198 are formed on opposite lateral sides of the primary coil 184 and are electrically connected to one another and to sensing circuitry in the manner described above with reference to FIG. 3. The manner in which the first and second secondary coils 196 and 198 are constructed and the structural components thereof may be the same as described above for the primary coil 184.

Another substrate layer 210 is formed on above the layer containing the upper conductor strips 192. The substrate layer 210 could also be formed as silicon dioxide, silicon nitride, or other passivation layers or any dielectric that may be formed on the silicon substrate in a wafer fab or in a post processing step (i.e. mold compound, or a laminated or deposited dielectric over the die surface). The substrate layer 210 may have a flat top surface 212 as shown in FIG. 4. An elongated displaceable member 220 made from magnetic material such as iron is supported at the top surface 212 of the substrate layer 210. The elongated displaceable member 220 may be constrained to straight line movement by an enclosing housing 222. Only a small portion of this housing 222 is shown in FIG. 4. The housing 222 may be constructed from a non-magnetic material such as plastic. In one embodiment (not shown) the housing 222 is a tubular housing with a central passage that slidingly accommodates the elongated displaceable member 220. An elongated mechanical linking member 224 is attached to one end of the elongated displaceable member 220. This elongated displaceable member 220 is connected to an object or to a mechanical linkage connected to an object to be monitored, as described above with reference to FIG. 2.

In other embodiments (not shown) the elongated displaceable member 220 is not confined by a housing 222 and is freely displaceable across the top surface 212 of the mold compound layer 210. Displaceable member 220 may be confined to planer movement as by capturing member 224 within a wide, elongated slot of a structural member (not shown) positioned adjacent to the silicon substrate 180. In this embodiment a second set of primary and secondary coils is wrapped around a second magnetic core that is positioned below the coils and magnetic core described above, This second magnetic core extends perpendicular to the first magnetic core. Differential signals from the secondary coils wrapped around the second core are analyzed in the same manner as described above for the first core. There may be some interference caused by the use of two magnetic cores and two sets of primary and secondary coils. Thus, with the second assembly, it may be necessary to calibrate the system by correlating the outputs of the two separate secondary coil assemblies with actual positions of the elongated member 220.

In yet another embodiment, the elongated member 220 may also be displaced upwardly with respect to the upper surface 212 of the layer 210. This vertical displacement will also have an effect on the signals produced by the two secondary coil assemblies. The signal change produced by vertical displacement may not be linear. However an indication of vertical displacement may be obtained by empirically correlating the actual position of the elongated displaceable member 220 with signal outputs.

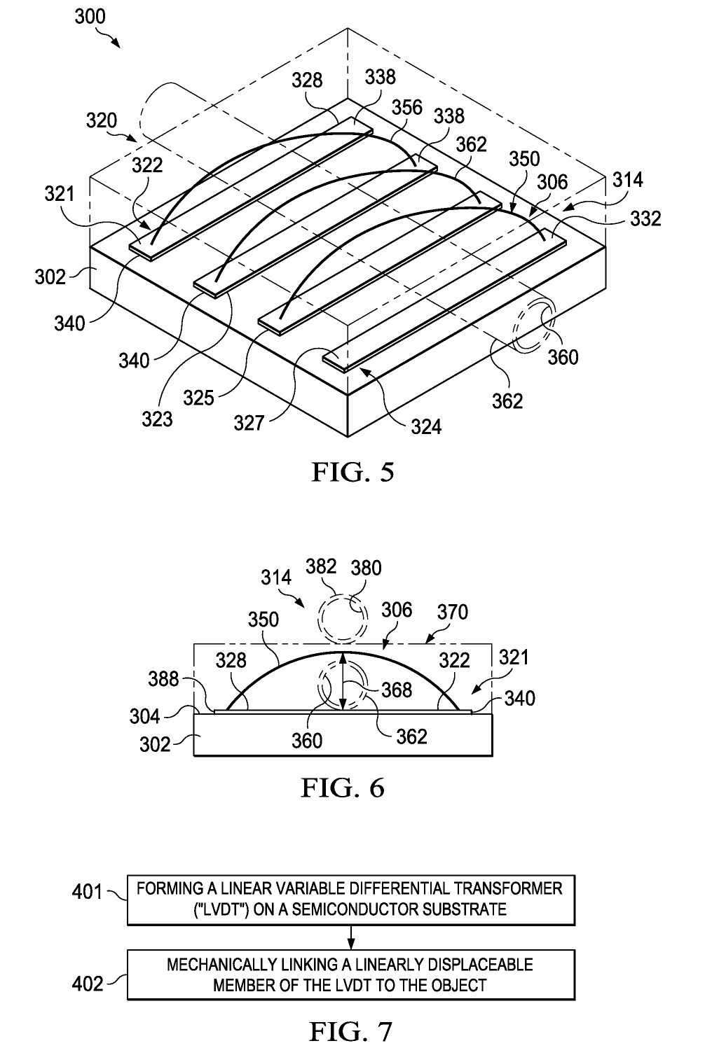

Another LVDT embodiment 300 is shown in FIGS. 5 and 6. As described in greater detail below, ferromagnetic material may be ground or atomized into powder that is added to a conventional transfer mold compound, referred to herein simply as “mold compound.” The addition of ferromagnetic material provides a mixed mold compound, which has an increased magnetic permeability over that of the original mold compound. The permeability of such mixed mold compound depends on the particle size of the powdered ferromagnetic material, the density of the ferromagnetic material, and many other known factors. By changing the particle size and density of the ferromagnetic material, the permeability of the mixed mold compound can be selected to fit specific design criteria.

In one embodiment, the ferromagnetic material used is known as sendust, which is approximately 85% iron, 9% silicon and 6% aluminum and has a relative permeability of up to 140,000. The above-described materials are mixed together and then formed into a powder, wherein the particles in the powder can have different sizes depending on the application. In other embodiments, versions of permalloy may be used as the ferromagnetic material. Permalloys may have different concentrations of nickel and iron. In one embodiment, the permalloy consists of approximately 20% nickel and 80% iron. Variations of permalloy may change the ratios of nickel and iron to 45% nickel and 55% iron. Other ferromagnetic materials include molybdenum permalloy which is an alloy of approximately 81% nickel, 17% iron and 2% molybdenum. Copper may be added to molybdenum permalloy to produce supermalloy which has approximately 77% nickel, 14% iron, 5% copper, and 4% molybdenum.

Having described some of the ferromagnetic materials that may be used in a mixture with mold compound, the LVDT coils, which may be encapsulated with such mold compound will now be described.

Circuits and methods of making circuits are described below wherein the circuits are encapsulated with a mold compound having the above-described ferromagnetic material dispersed throughout the mold compound. The ferromagnetic material serves to increase the permeability in the space proximate components in the circuit. The increased permeability improves the performance of many components on the circuit. Many of the improvements come from an increased inductance provided by the proximity of the components to the ferromagnetic material. For example, the increased permeability increases the inductance of inductors and conductors. Increased permeability also improves signal transmission properties of many conductors.

FIGS. 5 and 6 illustrate a substrate 302 having a surface 304 on which a plurality of coils 306 are formed. The substrate 301 and coils 306 may be constructed as described in U.S. Patent Application Publication No. US 2013/154148 A1, published Jun. 20, 2013, which is hereby incorporated by reference for all that it discloses. The coils 306 function as inductors and are sometimes referred to herein as “inductors 306”. As described in greater detail in the referenced publication, the substrate 302 is encapsulated and singulated to form the individual inductor assembly 314.

Referring to FIG. 5, the process of fabricating the inductor assemblies 314 commences with applying a plurality of conductors 320 to the surface 304 of the substrate 302. In FIG. 5, only a center portion of the substrate 302 that includes coil 306 is shown. However, it is to be understood that secondary coils (not shown in FIG. 5) are formed at either end of the primary coil 306 and these secondary coils may have the same structure as the primary coil 306. In the embodiments of the inductor assembly 314 described with reference to FIG. 5, the coil 306 has four conductors 320, which are referred to individually as a first conductor 321, a second conductor, 323, a third conductor 325, and a fourth conductor 327. The conductors 320 may be applied by any conventional technique for applying conductors to a substrate. The conductors 320 may be substantially parallel to each other as shown in FIG. 5. The layout of the conductors 320 forms the boundaries of the coil 306. Each coil 306 has a first end 322 and a second end 324. The first end 322 is defined as the outer edge 328 of the first conductor 321. In the embodiment of FIGS. 4 and 5 where each coil 306 has four conductors 320, the second end 324 of the coil 306 is defined by an outer edge 332 of the fourth conductor 327. Each of the conductors 320 has a first end 338 and a second end 340. The ends 338, 340 also form boundaries of the coil 306.

After the conductors 320 are applied to the substrate 302, wire bonds 350 are connected to the conductors 320 so as to electrically connect the conductors 320 to each other. As shown in FIG. 5, the second end 340 of the first conductor 321 is connected to the first end 338 of the second conductor 323 by a first wire bond 356. The second end 340 of the second conductor 354 is electrically connected to the first end 340 of the third conductor 325 by a second wire bond 362. This electrical connection scheme continues for the length of the coil 306. The conductors 320 and the wire bonds 350 at least partially define the coil 306.

As shown in FIG. 6, the wire bonds 350 form arcs spaced a distance 370 from the surface 104 of the substrate 310. The arcs each form a space between the wire bonds 350 and the conductors 320. In some embodiments, the distance 370 is approximately 120 mils (0.12 inches) or approximately 3.1 millimeters. As described in the above incorporated publication, a mold compound with the ferromagnetic material dispersed throughout encapsulates the coil 305. Accordingly, the distance 370 has to be great enough to allow the mold compound with the ferromagnetic material dispersed throughout to pass between the wire bonds 350 and the conductors 320.

It is noted that the inductance of the coil 306 and thus, the inductor assembly 314, is dependent on the length and width of the coil 306, the distance 370 between the conductors 320 and the wire bonds 350, the number of wire bonds 350 or windings in the coil 306, and several other factors, including the mold compound and the ferromagnetic material dispersed throughout the mold compound. The mixed mold compound is able to be located between the wire bonds 350 and the conductors 320. Because the mixed mold compound includes ferromagnetic material, the permeability of the space proximate the coil 306 is improved over a coil having air or just a mold compound located therein. The coil 306 is connected to a power source, which may be within, or more typically, outside of the substrate 302, as through use of contact pads (not shown) on the bottom and/or side faces of the substrate 302. As previously mentioned, only the middle portion of substrate 302, which contains the primary coil 306, is shown in FIGS. 5. Secondary coils (not shown in FIG. 5) are formed at opposite ends of the primary coil 306 in coaxial relationship therewith. The secondary coils may be connected to one another in series and may be connected to a sensor assembly (not shown) located within or outside of substrate 302. The secondary coils are not electrically connected to the first coil, but are magnetically coupled to the primary coil 306 like the secondary coils described above with reference to FIGS. 2-4.

In one embodiment, shown in phantom lines in FIGS. 5 and 6, a solid encapsulation block 370 is formed and, as shown only in FIG. 6, a displaceable member 380, shown in dashed lines, is linearly moveably supported on top of block 370, as by a nonconductive tubular member 382. Displacement of member 380 causes a differential signal to be produced by the secondary coils (not shown), which is indicative of the amount of displacement of the displaceable member 380 and any object attached thereto.

In another embodiment, as shown by alternating length dashed lines in FIGS. 5 and 6, the encapsulation block 370 has a nonconductive tubular member 362 extending through the block 370 in a region beneath the coils of the primary inductor 306, and the coils of the secondary inductors (secondary conductors not shown in FIGS. 5 and 6.) A cylindrical member 360 made from magnetic material, such as iron, is linearly displaceable within the tubular member 362. As in the other embodiment described above, displacement of member 360 causes a differential signal to be produced by the secondary coils (not shown), which is indicative of the amount of displacement of the displaceable member 360 and any object attached thereto.

FIG. 7 is a flowchart of a method of sensing the relative displacement of an object. The method includes, as indicated at 401, forming a linear variable differential transformer (“LVDT”) on a semiconductor substrate. The method also includes, as shown at 402, mechanically linking a linearly displaceable member of the LVDT to the object.

While various embodiment of a linear differential transformer (“LVDT”) constructed on a semiconductor substrate have been expressly disclosed herein in detail, various other embodiments of an LVDT may occur to those skilled in the art, after reading this disclosure. It is intended that the appended claims be broadly construed to cover such alternative embodiments, except as limited by the prior art.

What is claimed is:

1. A linear variable differential transformer (“LVDT”) comprising:
a semiconductor substrate; and
a plurality of coils formed at least partially on said substrate.

2. The LVDT of claim 1 further comprising:
a displaceable member positioned proximate to said plurality of coils and linearly displaceable relative to said semiconductor substrate.

3. The LVDT of claim 1 wherein said coils comprise:
a primary input coil having a first end and a second end;
a first secondary coil positioned adjacent said first end of said primary coil; and
a second secondary coil positioned adjacent said second end of said primary coil.

4. The LVDT of claim 3, said primary coil, said first secondary coil and said second secondary coil having parallel coil axes.

5. The LVDT of claim 3, said primary coil, said first secondary coil and said second secondary coil having coaxial coil axes.

6. The LVDT of claim 4 and further comprising a displaceable magnetic member positioned proximate said plurality of coils and linearly displaceable in a direction parallel to said coaxial coil axes.

7. The LVDT of claim 6, said displaceable member being positioned within said mold layer.

8. The LVDT of claim 6, and further comprising a mold layer covering said plurality of coils.

9. The LVDT of claim 8, said mold layer comprising magnetic particles dispersed therein.

10. The LVDT of claim 6, said displaceable member having a displacement axis coaxial with said coaxial coil axes.

11. The LVDT of claim 7, said displaceable member having a displacement axis laterally offset from said coaxial coil axes.

12. The LVDT of claim 6, said displaceable member having a first end attached to a first end of a mechanical linking assembly, a second end of said mechanical linking assembly being connected to an object, the displacement of which is to be measured.

13. The LVDT of claim 6, said primary coil being connected to an energy source, said first and second secondary coils being electrically connected to each other and inductively coupled to said primary coil, said electrically connected first and second secondary coil producing a combined output representative of displacement of said core member.

14. The LVDT of claim 13 and further comprising: electrical circuitry in said semiconductor substrate connected to said combined output of said first and second secondary coils; said electrical circuitry in said semiconductor substrate comprising at least one exposed contact surface for connecting said electrical circuitry in said semiconductor substrate to circuitry outside said substrate.

15. The LVDT of claim 1 further comprising an elongated magnetic core member positioned within said coils.

16. A method of sensing the relative displacement of an object comprising:
forming a linear variable differential transformer (“LVDT”) on a semiconductor substrate; and
mechanically linking a linearly displaceable member of the LVDT to the object.

17. A control system for controlling the operation of an apparatus containing a displaceable object:
a linear variable differential transformer (“LVDT”) including a semiconductor substrate, a primary coil and two secondary coils formed on a substrate and a linearly displaceable member positioned proximate said coils;
said first and second secondary coils being electrically connected and generating a displacement signal indicative of the relative displacement of a displaceable member; said displaceable member being mechanically linkable to said displaceable object; and
a control module receiving a signal based upon said displacement signal and issuing control signals to control operation of at least one component of said apparatus dependent upon said displacement signal.

18. The control system of claim 17 wherein said displaceable member is displaceable in two dimensions.

19. The control system of claim 17, said core member having a central longitudinal axis, said linearly displaceable member being displaceable in a direction parallel to said central longitudinal axis of said core member.

20. The control system of claim 17 further comprising a magnetic core member positioned within said coils.
